(19) United States
(12) Patent Application Publication
(10) Pub. No.: US 2014/0242245 A1
(43) Pub. Date: Aug. 28, 2014

(54) SHELF-STABLE BAKED CRISPS AND METHOD FOR MAKING SAME

(71) Applicant: FRITO-LAY NORTH AMERICA, INC., Plano, TX (US)

(72) Inventors: Martha Meadows BROWN, Grapevine, TX (US); Martin Bernhard DIERL, Allen, TX (US); Ponnattu Kurian JOSEPH, Irving, TX (US); Genevieve Barnard LAWSON, Carrollton, TX (US); Steve SCANNELL, Plano, TX (US); Supriya VARMA, Plano, TX (US)

(73) Assignee: FRITO-LAY NORTH AMERICA, INC., Plano, TX (US)

(21) Appl. No.: 13/780,357

(22) Filed: Feb. 28, 2013

(51) Int. Cl. A21D 13/00

(52) U.S. Cl. CPC A21D 13/0067
USPC 426/552; 426/560; 426/558; 426/553; 426/473

(57) ABSTRACT

A shelf-stable baked crisp and method for making the same. In one embodiment the shelf-stable crisp comprises a cooked batter which comprises oil, gluten, flour, baking powder, and egg. The crisp comprises a moisture content of between 2 and 5% and is shelf-stable. In one embodiment the crisp does not comprise artificial ingredients such as artificial preservatives, flavorings, or colorings. To manufacture the crisp, in one embodiment, the ingredients are first mixed to form a batter which is deposited into a pan and baked. Thereafter, the product is cooled, sliced, and then dried.

### BACKGROUND OF THE INVENTION

1. Technical Field

The present invention relates to a shelf-stable baked crisp and method for making same.

2. Description of Related Art

Many consumers of snack foods are becoming more health conscious and like to steer away from high fat/high sugar containing indulgent products. Often, such consumers desire baked products as opposed to fried snacks. Traditional cake is a baked snack food but it is not shelf-stable. Consequently, it is desirable to produce a shelf-stable baked snack product that can be consumed in the form of bakery crisps

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart of making a shelf-stable crisp in one embodiment.

FIG. 2 is a perspective view of a product-sized baking pan in one embodiment.

FIG. 3 is a perspective view of a non-product sized baking pan in one embodiment.

FIG. 4 is a perspective view of a baked shelf-stable crisp in one embodiment.

### DETAILED DESCRIPTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

A shelf-stable product is a product which, when packaged does not require refrigeration and is stable at typical ambient conditions for at least one month. In one embodiment, the product is shelf-stable for at least 6 months. A shelf-stable product is microbiologically safe and does not show significant organoleptic differences between the aged product and the fresh product. Shelf-stable products are convenient for a variety of reasons. First, shelf-stable products provide increased flexibility compared to short shelf-life products in supplying retail stores the product. Second, retailers appreciate shelf-stable product because this provides the retailer a longer opportunity to sell the product. Finally, consumers appreciate the product because they know they do not have to consume the product quickly. Thus, in many situations a shelf-stable product is beneficial.

A shelf-stable crisp is a crisp product which is shelf-stable. A crisp product refers to a crispy product which has a moisture content less than 10% by weight. In one embodiment the shelf-stable crisp comprises a moisture content of between 2% and 5% by weight, while in another embodiment the shelf-stable crisp comprises a moisture content of between 3% and 5%. In one embodiment the shelf-stable crisp comprises sweet baked product, such as a cake.

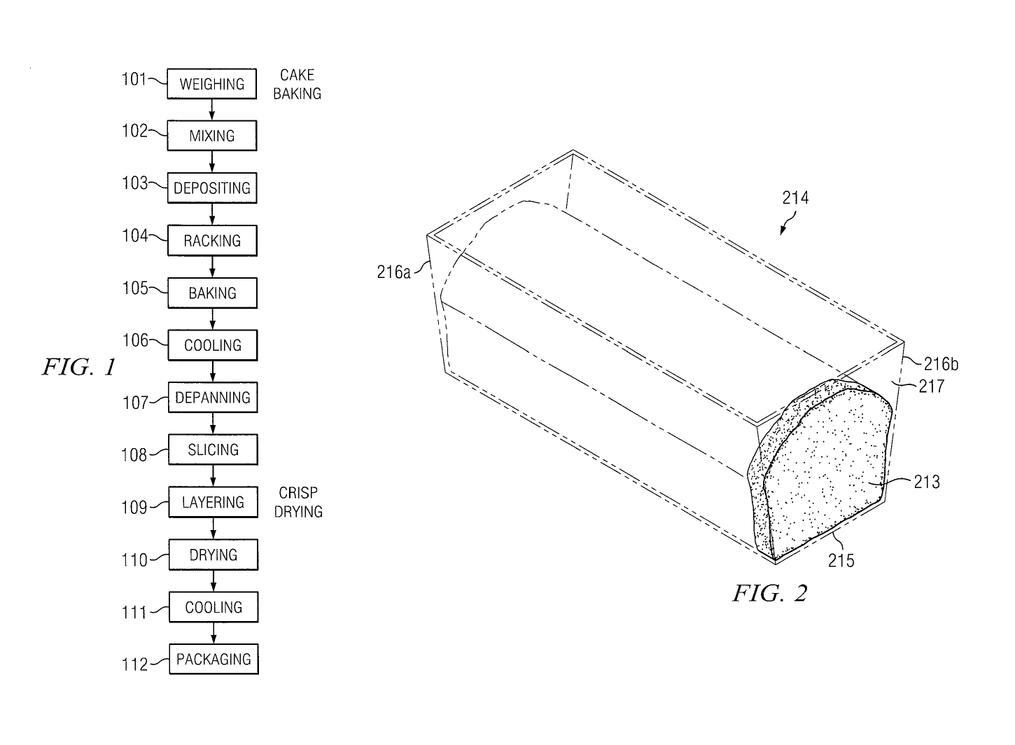

A method of making a shelf-stable crisp will now be discussed in reference to FIG. 1. FIG. 1 is a flow chart of making a shelf-stable crisp in one embodiment. It should be noted that this figure is for illustrative purposes and is not limiting. Other embodiments will comprise additional steps not shown whereas other embodiments will not have all the steps shown.

The first step is weighing 101 the ingredients. While described as weighing, this step comprises collecting the appropriate amount of ingredients. This step can comprise gathering or measuring via weight, volume, or other metric.

Next the ingredients are mixed in a mixing step 102. The mixing step 102 can comprise dry mixing, wet mixing, or combinations thereof. In one embodiment the dry ingredients are mixed before wet ingredients are added. Virtually any mixing equipment can be utilized in the mixing step 102. During the mixing step 102, the ingredients are formed into a batter. The moisture content of the batter can vary, but in one embodiment the moisture content ranges from about 25% to about 40%. In another embodiment the moisture content ranges from about 27% to about 35%.

A batter refers to a mixture which is less viscous than dough and which can be poured or dripped from a spoon. This is contrasted to a dough which is stiff enough to knead or roll. As will be discussed below, the batter can comprise many different ingredients. In one embodiment batter comprises oil and flour. In another embodiment it further comprises egg and baking powder.

As shown, after mixing step 102, the batter is deposited in a baking pan in a depositing step 103. In one embodiment, prior to the depositing step 103, the oil is added to the pan. This oil prevents the batter from sticking to the pan and assists in the subsequent removal of the product from the pan. Virtually any non-stick oil or substance can be utilized. In one embodiment the oil comprises Alube vegetable oil manufactured by Nealanders International, Inc. of Ontario Canada.

Virtually any type of baking pan can be utilized. In one embodiment a product-sized baking pan is utilized. As used herein, a product-sized baking pan is a baking pan so sized such that the final sliced product has a cross-sectional size which is substantially similar to the cross-sectional size of the baking pan. In one embodiment, the product-sized baking pan results in a final sliced product which has touched at least the bottom and two opposing sides of the baking pan. A product-sized baking pan is different from a non-product sized baking pan. For example, traditional square baking pans are non-product sized baking pan. Consider a cake pan with a dimension of 10 inches wide, by 10 inches long and 3 inches deep. While the cake substantially fills the square baking pan, the final sliced product does not have a cross-sectional size which is substantially similar to the cross-sectional size of the baking pan. Instead, the sliced product has a shorter width and length compared to the baking pan. Conversely, a product-sized baking pan results in a final sliced product which has a final sliced product which has a substantially similar cross-section compared to the product-sized baking pan.

FIG. 2 is a perspective view of a product-sized baking pan in one embodiment. As can be seen, the final sliced product 213 has a substantially similar cross-section compared to the product-sized baking pan 214. The final sliced product 213, as depicted, is the shelf-stable crisp in one embodiment. It can be seen that the final sliced product 213 has touched the bottom of the pan 215, and two opposing sides 216a, b of the pan. The end cap 217 is the side which connects the two opposing sides 216a, b. As can be appreciated, the product which is in contact with the end cap 217 is in contact with the bottom 216, the two opposing sides 216a, b, and the end cap 217.

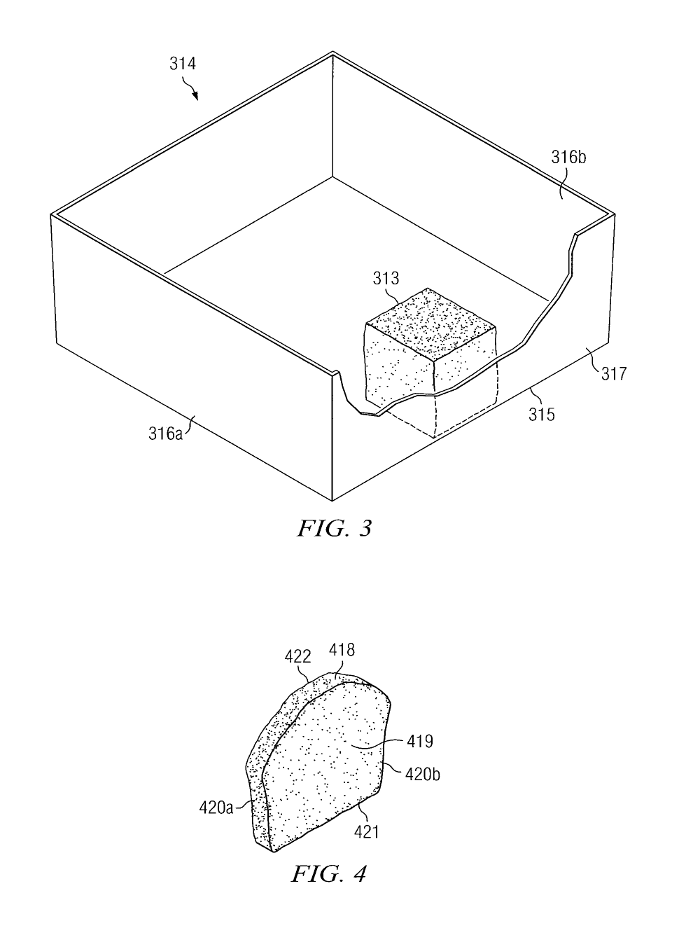

FIG. 3, by contrast, depicts a perspective view of a non-product sized baking pan in one embodiment. As shown, the final sliced product 313, in this case a piece of cake, does not have a substantially similar cross-section compared to the baking pan 314. Further, the final sliced product 313 did not touch three sides as it only touched the bottom.

A product-sized baking pan provides several unexpected advantages. First, because each sliced piece was in contact with at least the bottom side 215 and two opposed sides 216a, b, the sliced product has a crust along the entire product periphery. In one embodiment, each sliced piece has a crust along the entire periphery. This is a direct result of the contact with the pan. When the batter makes contact with a pan, this results in a crust. A product having crust around its periphery is preferred by consumers.

Second, a product-sized baking pan offers increased surface area which results in increased heat transfer. This is beneficial for both heating and cooling. As can be seen, because of the increased surface area, batter in a product-sized baking pan will bake more quickly compared to a non-product sized baking pan. Likewise, the increased surface area provides for increased cooling rates. Decreased heating and cooling times results in a decrease of total processing times which results in increased throughput. Third, because in one embodiment crust runs along the entire product periphery the product more resembles a slice of cake from a cake loaf which is desired by consumers.

In one embodiment, long and narrow baking pans are used rather than very large pans which produce slabs of cakes. For example, in one embodiment the baking pan utilized has a length from about 10 inches to about 20 inches. In one embodiment the baking pan has a length of about 17¾ inches. The height of the baking pan can vary but in one embodiment the height varies from about 2 inches to about 3 inches. In one embodiment the height is 2 5/16 inches. In one embodiment the width as measured at the top of the baking pan is greater than the width as measured at the bottom. In one embodiment the top of the baking pan ranges from about 2 to about 3 inches, whereas in another embodiment the top of the baking pan is about 2 27/32 inches. In one embodiment the bottom of the baking pan ranges from about 1.5 to about 3 inches, whereas in another embodiment the bottom of the baking pan is about 2⅛ inches.

Referring back to FIG. 1, after step 103 depositing the batter in pans, the pans are optionally racked in a racking step 104. A racking step 104 allows pans to be vertically placed atop one another which allows multiple pans to be placed within an oven to bake simultaneously.

After the optional racking step 104 is the baking step 105. The baking step 105 can take place in virtually any apparatus suitable for baking such as an oven. In one embodiment a batch oven is used for the baking step 105.

The temperature within the oven and the time that the batter is in the oven can be adjusted depending on the desired final product. In one embodiment the baking step 105 takes place at between 250 and 400° F. In one embodiment the baking step 105 takes place at 355° F. The baking time can vary but in one embodiment it ranges from about 25 to about 40 minutes. In one embodiment the baking time is around 35 minutes.

After the baking step 105, a first baked product is formed. The first baked product, in one embodiment, resembles a cake. In one embodiment, the first baked product comprises a moisture content between about 20% and 40%, while in other embodiments the moisture content ranges from about 27% to about 33%.

The first baked product is cooled in a cooling step 106. The cooling step 106 can comprise passive cooling in which the first baked product is allowed to cool without external equipment. The cooling step 106 can also comprise active cooling wherein cooling fans, cooling water, etc. are used to cool the first baked product. In one embodiment the first baked product is cooled to a temperature of between about ambient temperature to about 120° F. In another embodiment, the first baked product is cooled to a temperature of between about 90° F. to about 110° F.

After cooling, in one embodiment the first baked product is depanned in a depanning step 107. The depanning step 107 involves removing the first baked product from the pan. This can be accomplished using any device known in the art such as a spatula. In one embodiment this is accomplished via gravity. Because in some embodiments the pan comprised a non-stick pan or coating such as oil, in some embodiments the first baked product can be removed by flipping the pan upside down.

After depanning the first baked product is sliced in a slicing step 108. In one embodiment, the first baked product is sliced to a thickness of between about ⅛ to ½ of an inch. In another embodiment, the first baked product is sliced to a thickness of about ¼ of an inch. The thickness has an effect on the brittleness of the final product. A thicker product is less brittle and thus results in reduced breakage. However, with increased thickness the quantity of crisps that can be placed in a package is reduced leaving the customer thinking they were not provided a sufficient number of crisps. Further, a decreased thickness more resembles a traditional potato chip with which consumers are very familiar but which may exhibit increased tendency to break. Finally, a thicker piece has comparatively less surface area than a thinner piece and consequently takes more time to heat and cool. Thus, the brittleness, consumer grip, heat transfer, quantity of crisps, etc. are all factors which are affected by the selected thickness. In one embodiment, a ¼ inch thickness is optimal for a consumer's grip, breakage, heat transfer, quantity of crisps, etc. In one embodiment the crisp is bite sized or so sized to be consumed in one bite. In another embodiment the crisp is snack sized so as to be held in one hand and consumed in one or two bites.

Thinner slices such as ⅓ of an inch and below are often difficult to achieve on a consistent basis. Various slicers including knives, rotary slicers, etc. can be utilized. However, in one embodiment, the slicer comprises an ultrasonic slicer. An ultrasonic slicer has several benefits including increased uniformity of obtaining decreased thicknesses. Further, a soft and warm product, like a cake out of an oven, is often difficult to cut. However, an ultrasonic slicer provides adequate slices even if the first baked product is soft and warm. This is one unexpected ability of an ultrasonic slicer: the ability to cut product at elevated temperatures. Typically when slicing cake, the cake must be cooled to around ambient temperatures before it is sliced. Otherwise, the cake will not sufficiently slice. However, an ultrasonic slicer, compared to mechanical slicers, sufficiently slices warm and soft cake. As noted, temperatures of 110° F. or higher can be sliced with an ultrasonic slicer. The ability to slice higher temperature product decreases total processing time and therefore increases throughput. Put differently, using an ultrasonic slicer allows first baked product to be utilized and accordingly the first baked product need not cool to ambient temperatures before slicing. Thus, the cooling time, and as a result, the entire processing time, is decreased.

Additionally, the ultrasonic slicer does not disrupt the loaf structure of the first baked product compared to mechanical slicers. Many mechanical slicers will disrupt the mechanical structure and shape of the loaf. Because in one embodiment the shape of the loaf is to be maintained so as to mimic the shape of a slice of cake from a loaf, disrupting the loaf structure in such embodiments is to be avoided.

After slicing the product, the sliced first baked product is prepared for drying. In one embodiment the preparing comprises layering the first baked product in a monolayer. A monolayer of product promotes uniform drying compared to multiple layers. In one embodiment, after slicing 108, the sliced first baked product is spread onto a conveyor in a monolayer arrangement. The sliced first baked product is then delivered to a dryer for the drying step 110.

The drying step 110 removes additional moisture from the first baked product. In one embodiment the drying step 110 comprises a second baking step. The drying step 110 can take place in any dryer, which is any device which heats and removes moisture. These include batch and continuous ovens, including convection ovens. In one embodiment an impingement oven is utilized, and in one embodiment a continuous impingement oven is utilized. An impingement oven offers several advantages including increased heat transfer and increased uniformity.

In one embodiment the dryer is a single long continuous dryer. In another embodiment, however, the dryer comprises two or more dryers linked in series. Such an arrangement provides unexpected advantages including increased control. For example, in one embodiment six impingement ovens are connected in series. This provides the user an opportunity to split the oven into six distinct zones which can be independently controlled. Thus, for example, a higher temperature can be used in the first zone to speed the drying whereas a decreased temperature can be used in the final zone. Distinct zones provide an opportunity to specialize the temperature profile for a given product. This results in increased efficiency and a better final product.

The temperature of the dryer, in one embodiment, ranges from about 250 to about 350° F. After drying, a shelf-stable crisp is formed. In one embodiment, the shelf-stable crisp is dried to a moisture content of between 2% and 5%. In one embodiment the shelf-stable crisp is dried to a moisture content of between about 3% and about 4.5%. Such moisture contents are not traditionally used in many baked shelf-stable products. For example, often potato chips comprise a moisture content less than 2%. However, a shelf-stable crisp, if dried to a moisture content of less than 2% would be too brittle for the consumer. By having a comparatively higher moisture content compared to a potato chip, the crisp is sufficiently crispy without too much crisp which would resemble a fried product. Conversely, if a moisture content is too high, then the crisp does not comprise sufficient crispiness and is instead chewy like a cookie. Consequently, in one embodiment a moisture content between 2% and 5% results in a satisfactory crisp. Thus, in one embodiment, the shelf-stable comprises batter which has been cooked to a moisture content between about 2% and about 5%. A cooked batter refers to a product which originated as uncooked batter and has been cooked to a desired moisture content.

Such moisture contents also provide increased authenticity by mimicking a dried slice cake. Further, the moisture contents provide for low water activity and for reduced microbial growth and satisfactory crispiness. In one embodiment the moisture content provides for no microbial growth. Such factors contribute to the crisps ability to be shelf-stable.

After the drying step 110 the shelf-stable crisp is optionally cooled in a cooling step 111. As previously discussed, the cooling step 111 can comprise active or passive cooling. In one embodiment the cooling step 111 comprises a cooling conveyor. Cooling is advantageous because temperature differences after packaging can cause the product packaging to undesirably expand or contract. Thus, in one embodiment an optional cooling step 111 is utilized to allow the crisps to reach approximately room temperature before being packaged.

The crisps are then optionally packaged in a packaging step 112. Virtually any type of packaging can be utilized in the packaging step 112. In one embodiment pillow pouch packaging is utilized. In another embodiment a bag in a box packaging is utilized. A bag in a box, in one embodiment, offers the shelf-stability provided by a pillow pouch but with the additional protection afforded by the external box. Such an external box prevents breakage of the product. The crisps can be packaged with many different methods and devices including horizontal and vertical form, fill, and seal machines. FIG. 4 is a perspective view of a baked shelf-stable crisp in one embodiment. As can be seen, the shelf-stable crisp depicted comprises crust 418 along the entire periphery. As discussed, this is a benefit as consumers prefer such a product. The crust 418 is perceptible because the crust 418, in the depicted embodiment, comprises a comparatively darker color in view of a lighter crumb 419.

In the embodiment depicted the crisp comprises a bottom 421, a top 422 which connects two sides 420a, 420b. In one embodiment the top 422 is curved. In one embodiment the two sides 420a, 420b are slanted away from one another.

As depicted the crisp in FIG. 4 does not comprise significant ears or muffin tops. This results from using a pan which is sufficiently deep to avoid the batter raising above the height of the pan and overflowing the pan. Ears or muffin tops, in one embodiment, are avoided because they are easily broken resulting in undesirable broken pieces or crumbs in a package. Further, in such embodiments, significant ears are avoided so that the final product better resembles a slice of cake from a loaf. In other embodiments, however, where a muffin is being mimicked then ears are to be utilized.

As previously discussed, the crisp is shelf-stable. In one embodiment the crisp does not comprise artificial ingredients. Artificial ingredients are ingredients which do not exist or originate in nature. In one embodiment the crisp does not comprise artificial preservatives. The ability to be shelf-stable without utilizing artificial preservatives is an unexpected advantage as many consumers aim to limit their intake of artificial preservatives. Further, a consumer views a product which does not contain artificial preservatives as a healthier choice compared to a product comprising preservatives. To yield a shelf-stable crisp without using artificial preservatives the Applicants have discovered the disclosed formulation and method.

Additionally, in one embodiment the crisp does not comprise artificial flavors, colorings, sweeteners, and/or preservatives. As discussed, consumers often avoid such artificial ingredients. The crisp can comprise a variety of ingredients. In one embodiment the batter comprises added water. The amount of water added can vary from 0% to about 10% by weight of the batter or more. The amount of water added, if any, is dependent upon the moisture content in the other added ingredients.

In one embodiment sugar is added from about 0 to about 40% of the batter by weight, while in other embodiments sugar is added from about 10-40%. Sugar adds a sweet flavor to the crisp.

In one embodiment, flour, such as all purpose flour, is added from about 0 to about 40% of the batter by weight. In other embodiments flour is added from about 20-40% of the batter by weight. Virtually any type of flour, including but not limited to all purpose flour, buckwheat flour, rice flour, etc. can be utilized. Further, in one embodiment, baking powder is added from about 0 to about 2% of the batter by weight.

Eggs can also be added from about 0 to about 30% of the batter by weight. Eggs act as a binder as well as a protein source.

In one embodiment, oil is also added from about 0 to 20% of the batter by weight. In other embodiments oil is added from about 0% to about 10% of the batter by weight. Different types of oil can be utilized including vegetable oil. In one embodiment the oil comprises sunflower oil. In another embodiment the oil comprises high oleic sunflower oil which further comprises antioxidants. Such an oil is a shelf-stable oil.

Other ingredients may also be utilized including whole nuts or fruits. For example in a formulation of banana nut bread pecans are added to comprise about 0-10% of the batter by weight. In another embodiment pecans are added in an amount of 3-5% of the batter by weight. Likewise, in a formulation for lemon poppy seeds, poppy seeds are added into the batter formulation. Other ingredients can be added for taste including salt, sour cream powder, skimmed milk, and flavoring ingredients.

In one embodiment additional gluten is added to the formulation. This helps to minimize additional breakage. In one embodiment gluten, in the natural form, is added from about 0 to about 1% of the batter by weight.

The ingredients will be dependent upon the type of the desired final crisp. For example, in one embodiment the final crisp comprises banana nut bread crisp. Applicants have discovered that banana puree added from about 20% to about 40% by weight of the batter results in a desirable banana nut bread taste. In another embodiment banana puree comprises about 25% to 30% of the batter by weight.

Below is a formulation for a batter for vanilla pound cake.

TABLE 1
Formulation of Vanilla Pound Cake

| Ingredient | % |
|---|---|
| All Purpose Flour | 20-40% |
| Egg | 15-30% |
| Sugar | 10-40% |
| High Oleic Sunflower Oil with | 0-20% |
| Antioxidants | |
| Water | 0-10% |
| Skimmed Milk Powder | 0-5% |
| Natural Vanilla Flavor | 0-5% |
| Baking Powder | 0-2% |
| Gluten | 0-2% |

Below is a formulation for lemon poppy seed muffins.

TABLE 2
Formulation of Lemon Poppy Seed

| Ingredient | % |
|---|---|
| All Purpose Flour | 20-40% |
| Egg | 15-30% |
| Sugar | 10-40% |
| High Oleic Sunflower Oil with | 0-20% |
| Antioxidants | |
| Water | 0-15% |
| Sour Cream Powder | 0-10% |
| Baking Powder | 0-2% |
| Natural Lemon Flavor | 0-2% |
| Poppy Seeds | 0-2% |
| Gluten | 0-2% |

Below is a formulation for banana nut bread crisp.

TABLE 3
Formulation of Banana Nut Bread

| Ingredient | % |
|---|---|
| Banana Puree | 20-40% |
| Sugar | 20-40% |
| All Purpose Flour | 10-30% |
| Egg | 5-20% |
| High Oleic Sunflower Oil with | 0-15% |
| Antioxidants | |
| Pecans | 0-10% |
| Salt | 0-2% |
| Natural Flavor | 0-2% |
| Gluten | 0-2% |

The process for manufacturing a banana nut crisp from the banana nut bread batter formulation in Table 3 will now be discussed. This example is for illustrative purposes only and should not be deemed limiting.

First, the formulation was formed into a batter. The batter comprised a moisture content of about 34.7. Next, the batter was baked in a batch oven at a temperature of 355° F. for a time of about 33 minutes. The first baked product comprised a moisture content of about 33.0%. The first baked product was then cooled, depanned, and sliced with an ultrasonic slicer to a thickness of about ¼ of an inch. The sliced first product was conveyed in a monolayer to a continuous oven comprising of impingement ovens in series to form six baking zones. The first and second zones were about 320° F., the third zone was 310° F., the fourth, fifth, and sixth zones were 260° F. The independent zones provide increased control of baking, drying and browning. The finished crisp comprised a moisture content of about 3.6%. The crisp was then packaged with a vertical form, fill, and seal machine with an average breakage of 22%.

The below table, Table 4, details one embodiment of processing for each of the three formulations discussed above. These examples are for illustrative purposes only and should not be deemed limiting.

TABLE 4
Process Parameters

| | Vanilla | Lemon | Banana |
|---|---|---|---|
| Process Parameters | Pound Cake | Poppy Seed | Nut Bread |
| Baking | | | |
| Temperature(° F.) | 300-400 | 300-400 | 300-400 |
| Time (mins) | 20-40 | 20-40 | 20-40 |
| Drying | | | |
| Temperature(° F.) | | | |
| Zone 1 | 250-350 | 250-350 | 250-350 |
| Zone 2 | 250-350 | 250-350 | 250-350 |
| Zone 3 | 250-350 | 250-350 | 250-350 |
| Zone 4 | 250-350 | 250-350 | 250-350 |
| Zone 5 | 250-350 | 250-350 | 250-350 |
| Zone 6 | 250-350 | 250-350 | 250-350 |
| Time (mins) | 5-15 | 5-15 | 10-20 |
| Moisture Content (%) | | | |
| Batter | 20-35 | 20-35 | 20-35 |
| Cake | 20-35 | 20-35 | 20-35 |
| Crisp | 3-5 | 3-5 | 3-5 |
| Breakage through | 16% | 21% | 22% |
| VFFS machine (%) | | | |

As shown above, in one embodiment, the methods herein allow for the manufacture of shelf-stable products on an industrial manufacturing line. The result, in one embodiment, is the shelf-stable version of authentic traditional cakes. Virtually any flavor of cake can be obtained including lemon poppy seed, banana nut, vanilla pound cake, chocolate, vanilla, raspberry, cherry, strawberry, etc.

While in one embodiment a homogenous batter is used, in another embodiment non-homogenous batters are used. In one embodiment a dual batter system is utilized. A dual batter system allows for the final product to have marbling and swirls which are cosmetically pleasing to the consumer. In other embodiments more than two batters are utilized. In one embodiment one batter comprises a darker color compared which results in a contrasting color. In one embodiment the marbling or swirling is apparent from the face of the sliced product.

As discussed, in some embodiments the batter comprises inclusions such as nuts, fruit pieces, berries, etc. Such baked-in visual inclusions, which are visible to the consumer, are preferred by many consumers.

Furthermore, like cakes, the crisps in one embodiment comprises toppings or glazes. These toppings can include icing, chocolates, sprinkles, sugar coatings, streusels, etc.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
1. A shelf-stable crisp comprising:
   batter cooked to a moisture content of between 2 and 5%;
   wherein said shelf-stable crisp is shelf stable;
   wherein said crisp comprises a crust along the entire periphery of said crisp.
2. The shelf-stable crisp according to clause 1 wherein said crisp comprises a lighter crumb and a darker crust.
3. The shelf-stable crisp according to any preceding clause wherein said crisp has a thickness of about ¼ of an inch.
4. The shelf-stable crisp according to any preceding clause wherein said crisp has a dimension of about 2¼ inches long, about 2¼ inches wide, and about ¼ inch in thickness.
5. The shelf-stable crisp according to clause 4 wherein said crisp weighs between about 7 and 8 grams.
6. The shelf-stable crisp according to any preceding clause wherein said crisp does not comprise artificial ingredients.
7. The shelf-stable crisp according to any preceding clause wherein said oil comprises high oleic sunflower oil with antioxidants.
8. The shelf-stable crisp according to any preceding clause wherein said crisp does not comprise artificial flavorings.
9. The shelf-stable crisp according to any preceding clause wherein said crisp does not comprise artificial colorings.
10. The shelf-stable crisp according to any preceding clause wherein said crisp does not comprise artificial sweeteners.
11. The shelf-stable crisp according to any preceding clause wherein said crisp comprises a moisture content of between 3% and 5%.
12. The shelf-stable crisp according to any preceding clause wherein said crisp comprises preservatives.
13. The shelf-stable crisp according to clause 12 wherein said crisp does not comprise artificial preservatives.
14. The shelf-stable crisp according to any preceding clause wherein said crisp does not comprise artificial preservatives.
15. The shelf-stable crisp according to any preceding clause wherein said batter comprises oil.
16. The shelf-stable crisp according to any preceding clause wherein said batter comprises gluten.
17. The shelf-stable crisp according to any preceding clause wherein said batter comprises flour.
18. The shelf-stable crisp according to any preceding clause wherein said batter comprises egg.
19. The shelf-stable crisp according to any preceding clause wherein said batter comprises baking powder.
20. The shelf-stable crisp according to any preceding clause wherein said batter comprises oil, gluten, flour, baking powder, and egg.
21. A method of making a shelf-stable crisp, said method comprising:
   a. mixing ingredients to form a batter;
   b. depositing said batter into a pan;
   c. baking said batter to form a first baked product;
   d. cooling said first baked product;
   e. slicing said first baked product;
   f. drying said first baked product to form a shelf-stable crisp, wherein said crisp comprises a moisture content of between 2% and 5% by weight;
   wherein said pan comprises a product-sized baking pan;
   wherein said crisp comprises crust around the entire periphery.
22. The method according to clause 21 wherein said slicing comprises ultrasonic slicing.
23. The method according to clauses 21-22 wherein said cooling of step d) further comprises depanning said first baked product from said pan.
24. The method according to clauses 21-23 wherein said depositing of step b) further comprises racking multiple pans in a rack.
25. The method according to clauses 21-24 wherein said baking of step c) comprises a batch oven.
26. The method according to clauses 21-25 wherein said drying of step f) comprises drying in a continuous oven.
27. The method according to clauses 21-26 wherein said drying of step f) comprises drying in an impingement oven.
28. The method according to clauses 21-27 wherein said drying of step f) comprises drying in a monolayer.
29. The method according to clauses 21-28 further comprising step g) packaging said shelf-stable crisp.
30. The method according to clauses 21-29 wherein said crisp does not comprise artificial preservatives.
31. The method according to clauses 21-30 wherein said slicing comprises slicing to a thickness of about ¼ of an inch.
32. The method according to clauses 21-31 wherein said baking of step c) comprises baking to a moisture content of between 25 and 35%.
33. The method according to clauses 21-32 wherein said crisp comprises a moisture content of between 3% and 5%.

What is claimed is:

1. A shelf-stable crisp comprising:
batter cooked to a moisture content of between 2 and 5%;
wherein said shelf-stable crisp is shelf stable;
wherein said crisp comprises a crust along the entire periphery of said crisp.

2. The shelf-stable crisp of claim 1 wherein said crisp comprises a lighter crumb and a darker crust.

3. The shelf-stable crisp of claim 1 wherein said crisp has a thickness of about ¼ of an inch.

4. The shelf-stable crisp of claim 1 wherein said crisp has a dimension of about 2¼ inches long, about 2¼ inches wide, and about ¼ inch in thickness.

5. The shelf-stable crisp of claim 4 wherein said crisp weighs between about 7 and 8 grams.

6. The shelf-stable crisp of claim 1 wherein said crisp does not comprise artificial ingredients.

7. The shelf-stable crisp of claim 1 wherein said oil comprises high oleic sunflower oil with antioxidants.

8. The shelf-stable crisp of claim 1 wherein said crisp does not comprise artificial flavorings.

9. The shelf-stable crisp of claim 1 wherein said crisp does not comprise artificial colorings.

10. The shelf-stable crisp of claim 1 wherein said crisp does not comprise artificial sweeteners.

11. The shelf-stable crisp of claim 1 wherein said crisp comprises a moisture content of between 3% and 5%.

12. The shelf-stable crisp of claim 1 wherein said crisp comprises preservatives.

13. The shelf-stable crisp of claim 12 wherein said crisp does not comprise artificial preservatives.

14. The shelf-stable crisp of claim 1 wherein said crisp does not comprise artificial preservatives.

15. The shelf-stable crisp of claim 1 wherein said batter comprises oil.

16. The shelf-stable crisp of claim 1 wherein said batter comprises gluten.

17. The shelf-stable crisp of claim 1 wherein said batter comprises flour.

18. The shelf-stable crisp of claim 1 wherein said batter comprises egg.

19. The shelf-stable crisp of claim 1 wherein said batter comprises baking powder.

20. The shelf-stable crisp of claim 1 wherein said batter comprises oil, gluten, flour, baking powder, and egg.

21. A method of making a shelf-stable crisp, said method comprising:
a. mixing ingredients to form a batter;
b. depositing said batter into a pan;
c. baking said batter to form a first baked product;
d. cooling said first baked product;
e. slicing said first baked product;
f. drying said first baked product to form a shelf-stable crisp, wherein said crisp comprises a moisture content of between 2% and 5% by weight;
wherein said pan comprises a product-sized baking pan;
wherein said crisp comprises crust around the entire periphery.

22. The method of claim 21 wherein said slicing comprises ultrasonic slicing.

23. The method of claim 21 wherein said cooling of step d) further comprises depanning said first baked product from said pan.

24. The method of claim 21 wherein said depositing of step b) further comprises racking multiple pans in a rack.

25. The method of claim 21 wherein said baking of step c) comprises a batch oven.

26. The method of claim 21 wherein said drying of step f) comprises drying in a continuous oven.

27. The method of claim 21 wherein said drying of step f) comprises drying in an impingement oven.

28. The method of claim 21 wherein said drying of step f) comprises drying in a monolayer.

29. The method of claim 21 further comprising step g) packaging said shelf-stable crisp.

30. The method of claim 21 wherein said crisp does not comprise artificial preservatives.

31. The method of claim 21 wherein said slicing comprises slicing to a thickness of about ¼ of an inch.

32. The method of claim 21 wherein said baking of step c) comprises baking to a moisture content of between 25 and 35%.

33. The method of claim 21 wherein said crisp comprises a moisture content of between 3% and 5%.
